(19) United States
(12) Patent Application Publication
(10) Pub. No.: US 2004/0189755 A1
(43) Pub. Date: Sep. 30, 2004

(54) Authentication of a remote user to a host in data communication system

(76) Inventor: John William Studholme, Lincolnshire (GB)

Correspondence Address: PEARNE & GORDON LLP, 1801 EAST 9TH STREET, SUITE 1200, CLEVELAND, OH, 44114-3108, US

(21) Appl. No.: 10/487,348

(22) PCT Filed: Nov. 18, 2003
(86) PCT No.: PCT/GB03/04982

(30) Foreign Application Priority Data
Nov. 3, 2001 (GB) 01264266

(51) Int. Cl. B41J 2/175

(52) U.S. Cl. 347/86

(57) ABSTRACT

An ink cartridge for a printer comprises three storage tanks 12, each with an ink supply outlet 17. A filter sheet 64 is attached to an ink absorbing member 62 of the same dimensions in plan as the internal dimensions of a tank 12. The ink absorbing member 62 is inserted into the tank 12 so that the filter 64 is over the ink outlet 17.

The invention relates to an ink cartridge for a printer, a method of assembling an ink cartridge for a printer, and a filter assembly for an ink cartridge and a combined filter.

When ink is stored in a cartridge, variations in temperature will affect the gas solubility of the ink. Thus, increases in temperature may cause out-gassing, forming bubbles, which can disrupt printing. Irrespective of temperature variations, dye-based inks may form gasses over a period of time. It is known that a filter placed in line with the ink supply is advantageous in preventing bubbles from reaching the printer head. A filter will also filter out any particles in the ink.

A cartridge including a filter is known from EP-A-553535. This document discloses a cartridge comprising an ink storage tank and an ink supply port. The tank is in the form of an open topped box with a lid. The ink supply port is defined by a pipe and is formed in the lower part of the tank. The ink supply port pipe depends downwardly from the tank to receive an ink withdrawal needle, and also extends inwardly into the tank. The upper end of the ink supply port pipe has a stainless steel mesh filter fused bonded onto it. A porous member which is wider and taller than the tank is forced into the tank and engages the filter and is compressed by the end of the protruding ink supply port pipe inside the tank. The porous member stores ink in the tank.

Placement and bonding of the filter in the known cartridge is difficult. The end of the ink supply port pipe where the filter must be placed is down inside the cartridge. There is little room inside the tank. Such cartridges are supplied with three, four or even five colours in separate chambers, and in such five chamber cartridges, the chambers can be as little as 5 or 6 millimetres wide, severely limiting the space available to carry out the operations of placement and bonding of the filter.

According to one aspect of the invention there is provided a method of assembling an ink cartridge for a printer, the cartridge having an ink storage tank and an ink supply outlet from the tank, the method comprising the steps of: attaching a filter to a negative pressure producing member, and inserting the negative pressure producing member into the tank so that the filter is over the ink supply outlet.

The negative pressure producing member can be much larger than the filter, which is generally small and therefore fiddly and difficult to handle in comparison with the negative pressure producing member. By attaching the two together, the result is an assembly which is much easier to handle. This also reduces the number of manufacturing steps significantly as, in comparison with EP-A-553535, the steps of inserting the filter and porous member are carried out in one operation instead of two, and the step of attachment to the ink supply port pipe is omitted altogether.

The negative pressure producing member is suitably a member whose capillarity provides a negative pressure, preventing gravity from causing an uncontrolled release of ink from the cartridge. The negative pressure producing member may thus be a porous member, and can be a foam, a felted foam, a mat constructed of packed fibres and in one embodiment preferably is an extruded piece of fibrous material.

The negative pressure producing member may frictionally engage at least two walls of the tank so as to hold itself in place. Alternatively or additionally, the negative pressure producing member may be held in place in the tank by other means.

The filter may be attached to the negative pressure producing member by application of heat to fuse the filter to the negative pressure producing member, or by ultrasonics or by adhesive. At least part of the filter may be made of plastics material. The negative pressure producing member may also be made of plastics material. The filter may be in the form of a sheet.

According to another aspect of the invention there is provided a method of assembling an ink cartridge for a printer, the cartridge having an ink storage tank and an ink supply outlet from the tank, the method comprising the steps of: placing a filter over the ink outlet and placing a negative pressure producing member into the tank, the negative pressure producing member holding the filter in place.

In this way, the step in the known assembly process of fuse bonding the filter to the top of the ink supply port is not required.

The filter may have the same width as the width of the tank. In this way it is easier to place and no errors can be made in placement in the width direction of the tank. The filter also preferably or alternatively is arranged to engage the end of the wall of the tank in which the ink outlet is formed when located over the outlet. In a preferred embodiment, the outlet is in the floor of the tank, and the floor is preferably flat.

The filter can be any suitable material such as a synthetic woven or non-woven material and can have a mesh opening size of between 1 and 50 micrometres, preferably 1 to 10 micrometers in one preferred embodiment 7 to 10 micrometres.

Preferably, the effective area of the ink outlet increases into the tank. The filter can thus be larger than in the case of an equivalent parallel sided port, for example, as shown in EP-A-553535, and so filtration can take place over a larger area, increasing efficiency and extending the effective life of the filter, because the filter will take longer to clog, as it has a larger surface area. The entry to the outlet may be increased in area in any suitable way and there may be a channel in the tank leading to the outlet.

Preferably the ink outlet does not protrude beyond the floor of the tank.

Preferably a second negative pressure producing member is provided which is placed on the opposite side of the first negative pressure producing member from the filter and which may have a larger pore size than the first negative pressure producing member. This enables more ink to be removed from the cartridge. The ink in the larger pore size second negative pressure producing member will be drawn by capillary action into the first negative pressure producing member as ink is withdrawn from the cartridge. As the filter prevents air from passing into the ink outlet, the first negative pressure producing member can be substantially emptied of ink. This contrasts with known cartridges which generally have to be discarded still with a significant amount of ink in them. A cartridge which has a single negative pressure producing member and no filter will be discarded with a significant amount of ink therein which cannot be accessed for printing. This is reduced by the use of two negative pressure packaging members, the one closer to the ink matter being of smaller pore size. By including a filter as well, almost all of the ink in the smaller pore size negative pressure packaging member can be extracted for printing. In this way, more pages can be printed for the same volume of ink, or, if preferred, a reduced ink volume can be provided in the cartridge to print the same number of pages. Either way, greater efficiency in ink use results.

According to another aspect of the invention there is provided a filter assembly for an ink cartridge for a printer, the assembly comprising a negative pressure producing member and a filter connected thereto.

According to another aspect of the invention there is provided an ink cartridge for a printer, the cartridge comprising an ink storage tank with an ink supply outlet from the tank, and a filter over the ink supply outlet but separate from the outlet and the tank.

According to a further aspect of the invention there is provided an ink cartridge for a printer, the cartridge comprising an ink storage tank and an ink supply outlet from the tank, a negative pressure producing member held in place in the tank and the filter held in place by the negative pressure producing member.

Preferably, the filter is connected to the negative pressure producing member.

Ink cartridges for printers generally include an air hole. Thus, as ink is taken from the cartridge for printing, air is allowed to enter from atmosphere through the air hole so that a negative pressure does not build up inside the cartridge which would resist further supply of ink from the cartridge. Known cartridges also tend to include a fill hole, through which ink is injected into the cartridge, and may also include an extraction hole, through which air is extracted from the cartridge during filling with ink.

EP-A-1024009 discloses a cartridge comprising a tank in the form of an open topped container with a lid. An air hole, fill hole and extraction hole are each defined in the lid. Each hole takes the form of a short tube depending from the lid into the tank. The fill hole and extraction hole are each blocked by a ball bearing after filling.

According to a further aspect of the invention there is provided an ink cartridge for a printer, the cartridge comprising a tank with a lid, the lid defining one or more of an air hole, fill hole and extraction hole, and the under surface of the lid being flat.

Embodiments of the invention will now be described by way of example and with reference to the accompanying drawings, in which:

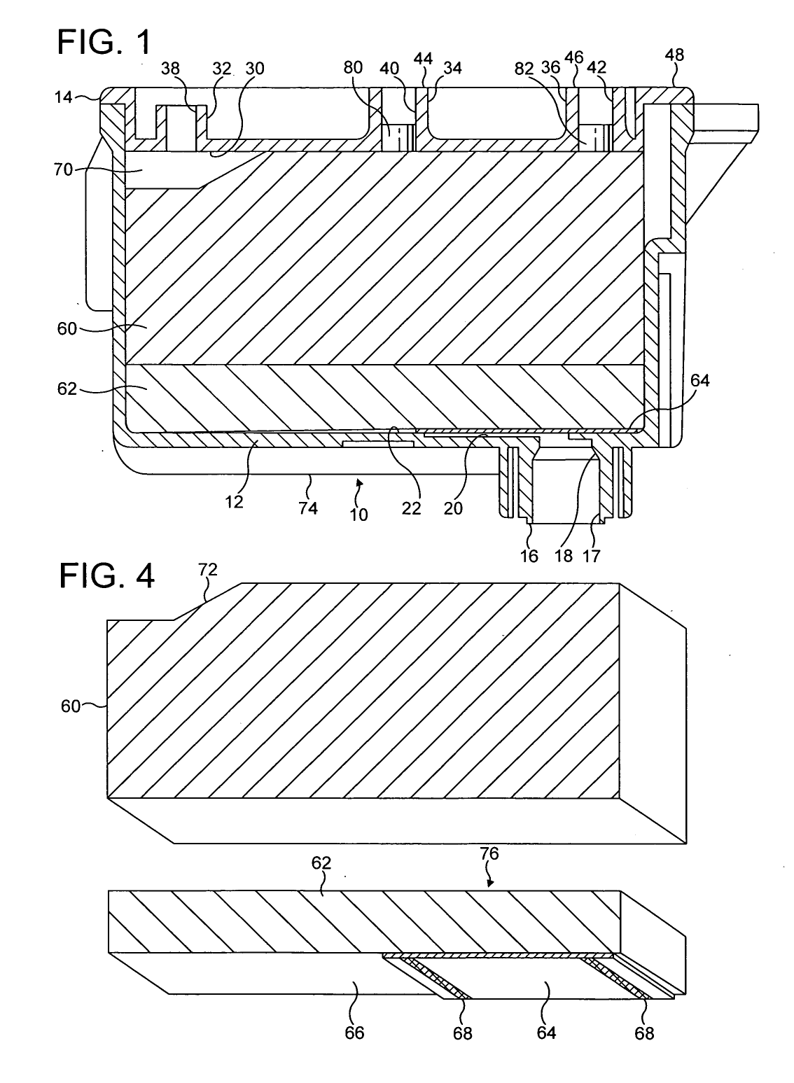

FIG. 1 is a side elevation in cross section of a cartridge in a first embodiment of the invention;

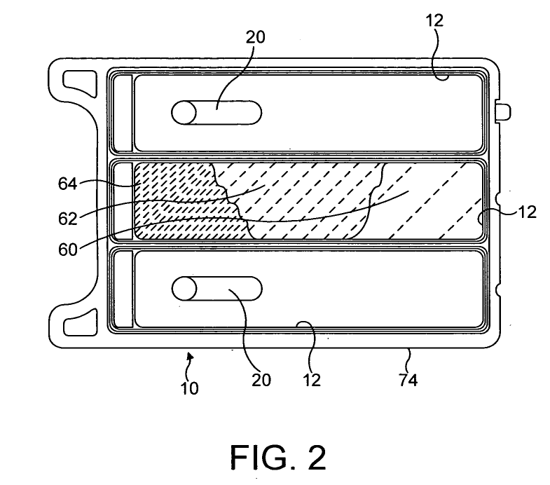

FIG. 2 is a plan view of the cartridge of FIG. 1 with the two outer tanks empty;

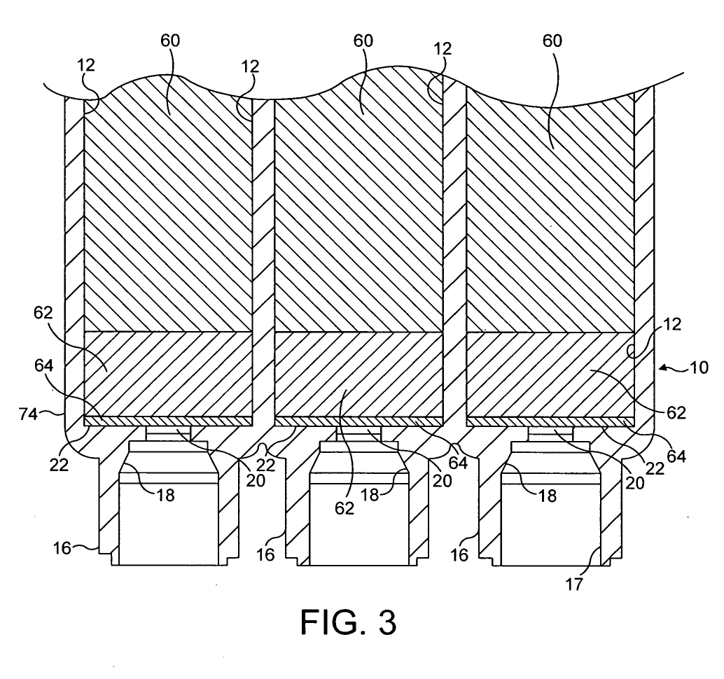

FIG. 3 is a fragmentary front elevation in cross section through the ink outlets of the cartridge;

FIG. 4 is a perspective view of the ink absorbing members of one tank of the cartridge of FIG. 1;

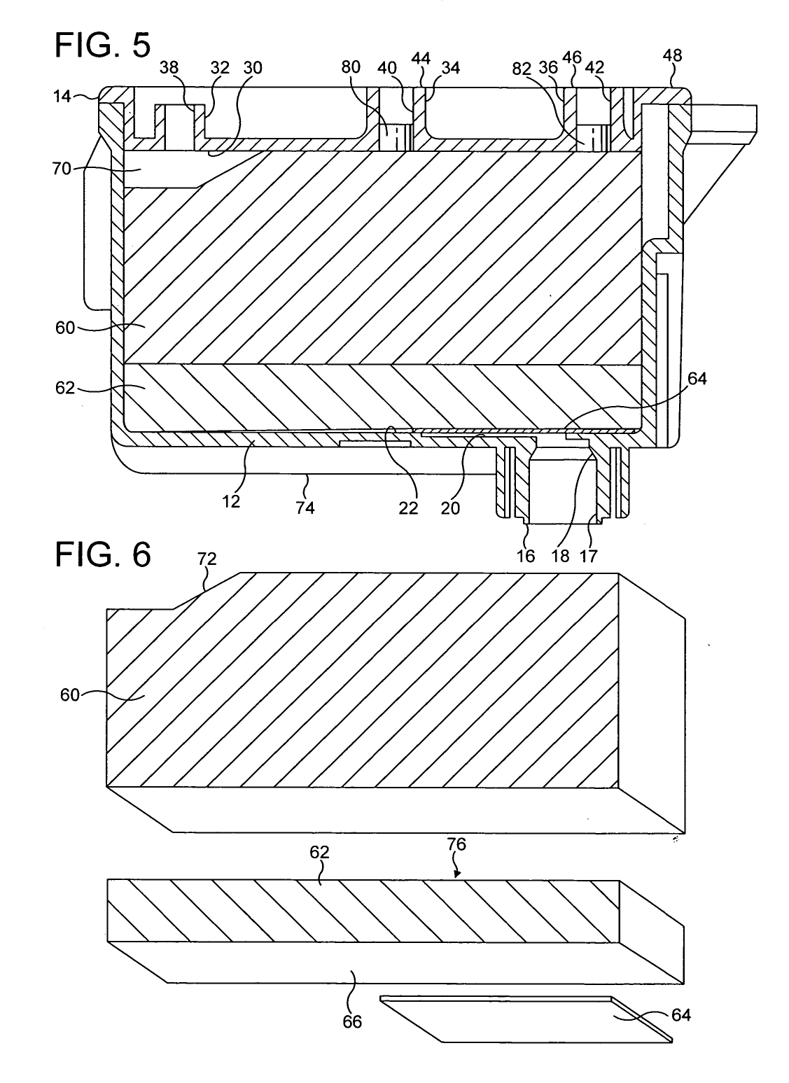

FIG. 5 is a side elevation in cross section of a cartridge in a second embodiment of the invention;

FIG. 6 is a perspective view of the ink absorbing members and filter from a tank from the cartridge of FIG. 5;

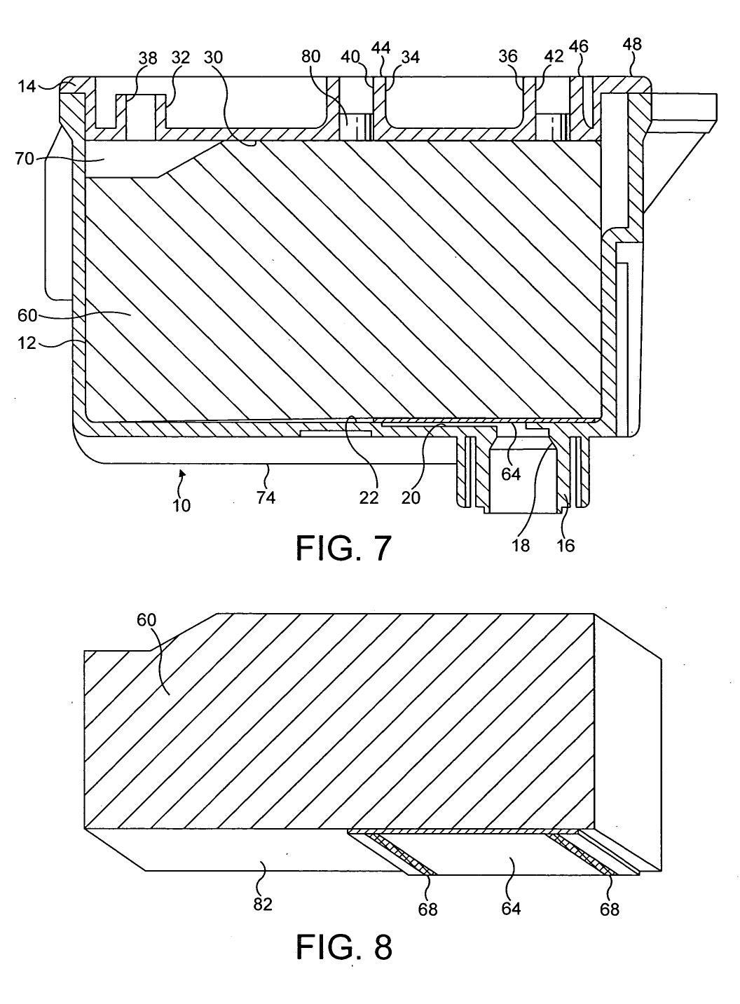

FIG. 7 is a side elevation in cross section of a cartridge in a third embodiment of the invention;

FIG. 8 is a perspective view of the ink absorbing member of one tank of the cartridge of FIG. 7;

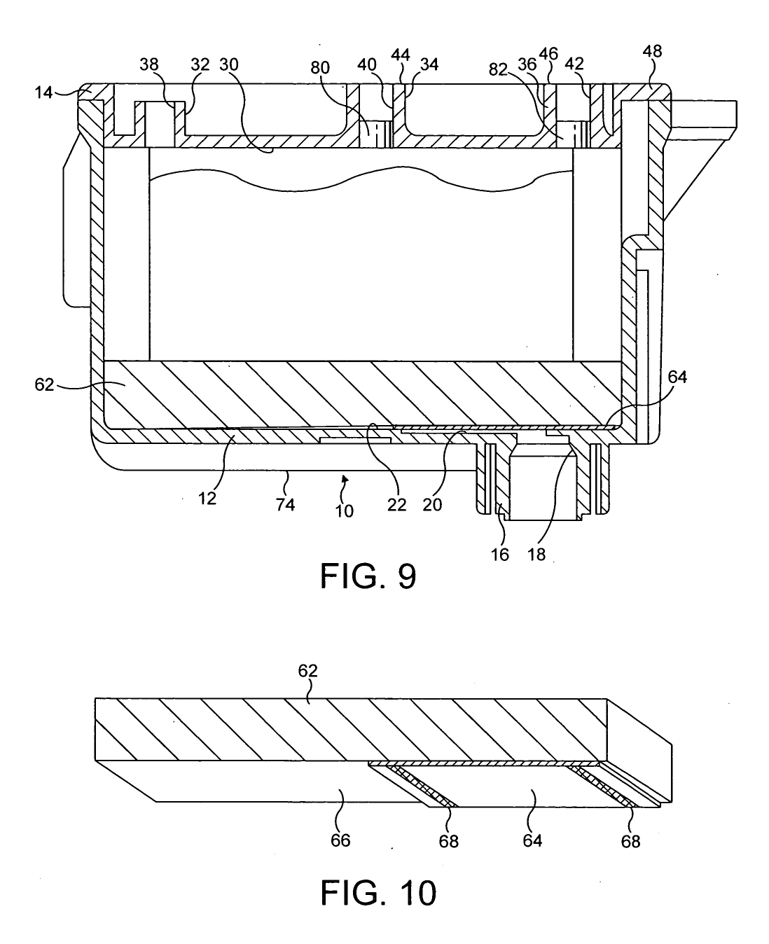

FIG. 9 is a side elevation in cross section of a cartridge in a further embodiment of the invention;

FIG. 10 is a perspective view of the ink absorbing member of the cartridge of FIG. 9;

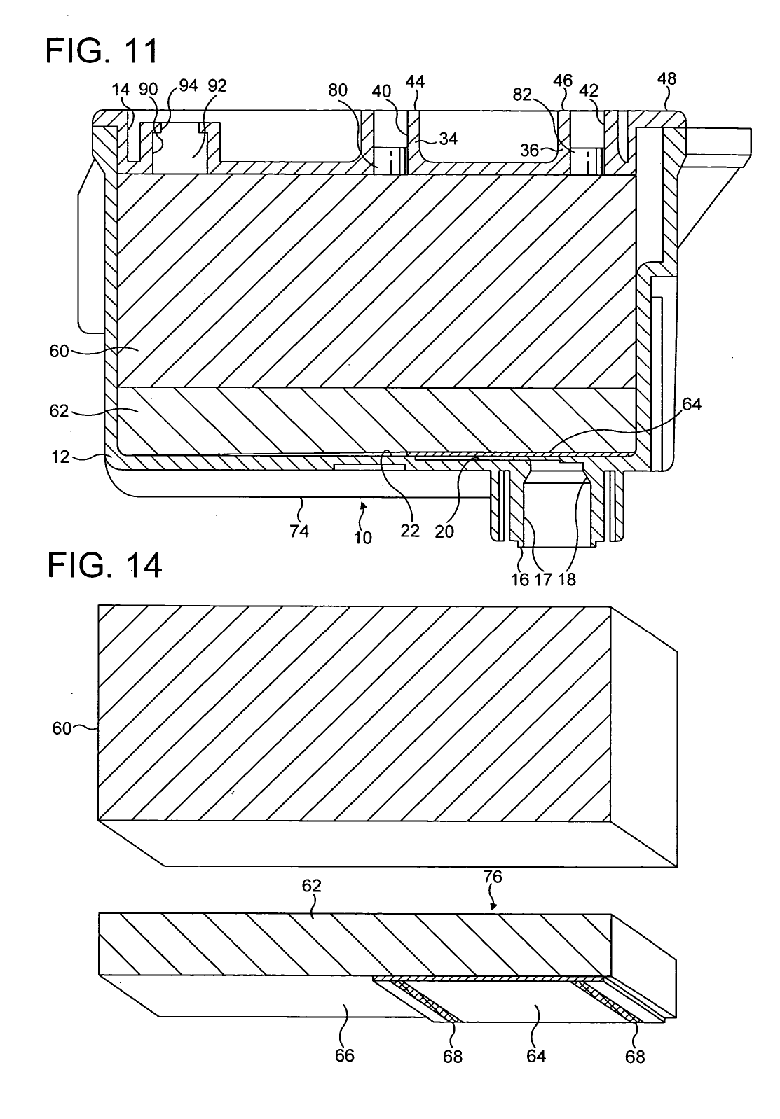

FIG. 11 is a side elevation in cross-section of a cartridge in another embodiment of the invention;

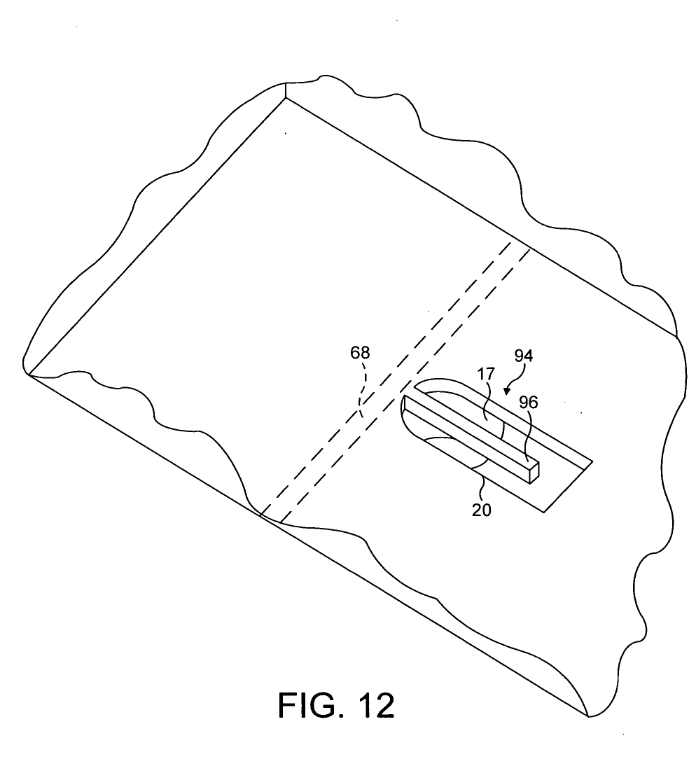

FIG. 12 is a fragmentary detail perspective view of the floor of the cartridge of FIG. 11;

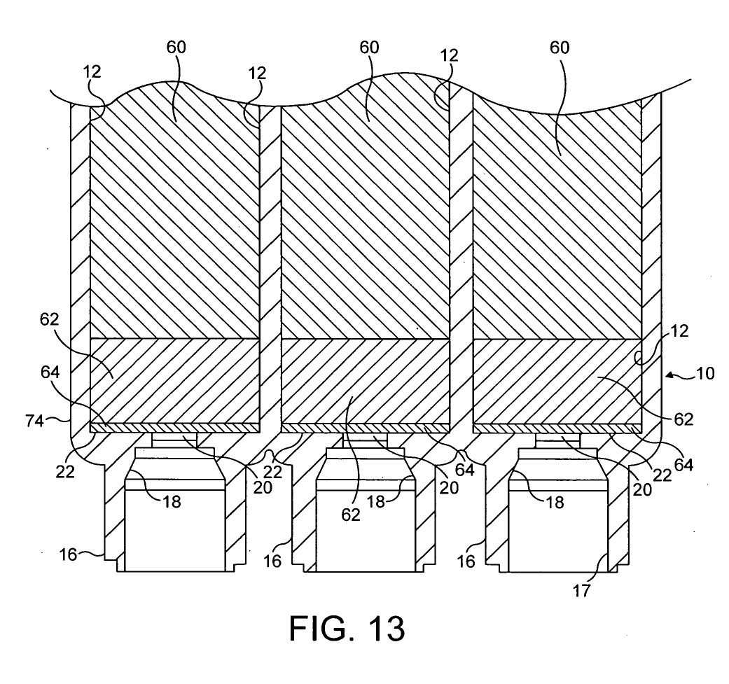

FIG. 13 is a fragmentary front elevation in cross-section through the ink outlets of the cartridge of FIG. 11; and

FIG. 14 is a perspective view of the ink absorbing members of one tank of the cartridge of FIG. 11.

The cartridge 10 of the first embodiment comprises three ink storage tanks 12 integrally formed side by side, each ink storage tank 12 being in the shape of a generally rectangular box. Each ink storage tank 12 is closed by an upper lid 14. An ink outlet tube 16 depends from each ink tank 12.

Each ink outlet tube 16 defines an ink outlet port 17 which is parallel sided over most of its length then narrows through a tapered section 18 before intersecting a channel 20 in the floor 22 of the tank 12. The channel 20 forms a long shallow groove which is relatively wide and is rounded at each end when viewed in plan. The channel 20 intersects the bore of the tube 16 and terminates about half way across the bore.

The lids 14 of the tanks 12 are integral. Each lid 14 is generally tray shaped and is arranged to be push-fitted into the open top of the tank 12. The underside 30 of each lid 14 is flat. Each lid 14 defines three short upwardly extending tubes 32, 34, 36, which have through bores 38, 40, 42 communicating with the interior of the tank 12. The tubes 32, 34, 36, respectively define an air hole, a fill hole and an extraction hole 38, 40, 42. The ends 44, 46 of the fill hole tube 34 and the extraction hole tube 36 are flush with the top of the outer rim 48 of the tray shaped lid 14. The upper end of the air hole tube 32 is below the level of the upper surface of the rim 48 of the tray shaped lid 14.

Within each tank 12 are two ink absorbing members 60, 62. Each ink absorbing member 60, 62 has substantially the same dimensions as the internal dimensions of the tank 12 in plan. The upper ink absorbing member 60 is larger and is made of a synthetic sponge material which may be a plastics foam such as urethane foam. The lower ink absorbing member 62 may be an extruded piece of fibrous material such as that sold under the trade mark “FILTRONA”. The pore size of the larger ink absorbing member 60 is larger than the pore size of the smaller ink absorbing member 62. A filter sheet 64 is attached to the underside 66 of the lower pore size ink absorbing member 62. The filter 64 is made of a synthetic woven material with a mesh size of about 9 micrometres. The filter sheet 64 is the same width as the low pore size ink absorbing member 62 and extends from one end of the ink absorbing member 62 to almost half way along its length. The filter sheet 64 is attached to the low pore ink absorbing member 62 by fuse bonding along two parallel lines 68, one at each end of the filter sheet 64.

The low pore size ink absorbing member 62 occupies between 20 and 25% of the internal volume of the tank 12. The remainder of the volume is occupied by the larger pore size ink absorbing member 60 except for an air gap 70 beneath the air hole 38 which is formed by a cut-out 72 in the larger pore size ink absorbing member. The ink absorbing members 60, 62 are dimensioned so that their overall height is the same as or slightly larger than the overall height of the interior of the tank 12.

In manufacture of the cartridge, the cartridge lid 14 is injection moulded from suitable plastics material as one moulding and the remainder of the body 74 of the cartridge 10 is manufactured as a separate injection moulding out of another suitable plastics material which may be the same as the first. A sheet of the material from which the low pore size ink absorbing member 62 is made may be cut into a strip of the desired thickness, whose width is the length of the eventual ink absorbing member 62. A sheet of the filter material 64 whose width corresponds to the length of the eventual filter 64 may be laid over the long strip of low pore size ink absorbing material and attached to it by the application of heat along two parallel lines to fuse bond the filter material to the low pore size ink absorbing material. The long strip may then be sliced transversely to the width of the eventual ink absorbing member 62 so that a plurality of assemblies 76 result each of which consists of a low pore size ink absorbing member 62 with a filter 64 attached thereto. Each assembly 76 is inserted into a tank 12 of a cartridge body 74.

It is seen that, because the low pore size ink absorbing member 62 has the same dimensions in plan as the internal dimensions of the tank 12, it acts to locate itself and thereby to locate the filter sheet 64 which is attached thereto. The filter sheet 64 is therefore guaranteed to be placed in the correct place over the channel 20 which forms the inlet of the ink supply port. The filter sheet 64 is so long that it covers the whole of the channel 20 and the fuse bonding lines 68 are beyond the ends of the channel 20. Thus ink passes through the central part of the filter sheet 64, between the fuse bonding lines 68 into the channel 20 and thence into the outlet port 17.

Each larger pore size ink absorbing member 60 is cut from a block of the appropriate material and is then inserted into each tank 12 on top of the lower pore size ink absorbing member 62. The lid 14 is then pushed into place on top of the cartridge body 74. Needles are inserted through the fill hole 40 and extraction hole 42 so that ink can be injected into the cartridge 10 while a vacuum is drawn onto the cartridge through the extraction hole 42. The fill hole and extraction holes are then plugged with plugs 80, 82.

It can thus be seen that manufacture of the cartridge is simplified and made more efficient by means of the invention. It is also seen that the large filter sheet 64 provides a large area for filtration. The channels 20 extend the effective area of opening of the ink supply port. The fact that the ink absorbing members 60, 62 are not substantially oversized saves on the material. The flat under surface of the lid 14 ensures that the entire interior of the tank 12 is free from any protrusions.

The second embodiment of the invention is similar to the first and the same reference numerals will be used for equivalent features. Only the differences from the first embodiment will be described.

In the second embodiment, the filter sheet 64 is not attached to the low pore size absorbing member 62. The filter 64 must therefore be placed into the cartridge body 74 in a separate operation, but the fact that it is of the same width as the tank 12 and fits into the end of the tank 12 means that it can be dropped into the tank 12 and slid up against the end of the tank 12 and then will be in exactly the right position being located by the sides of the tank. The low pore size ink absorbing member 62 is then inserted on top of it to hold it into place, and the larger pore size ink absorbing member 60 is inserted on top of the lower pore size ink absorbing member 62 in the manner previously described.

The third embodiment is again similar to the first embodiment and the same reference numerals will be used for equivalent features. Only the differences from the first embodiment will be described.

In the third embodiment, the lower pore size ink absorbing member 62 is omitted, and the larger pore size ink absorbing member 60 is made deeper so as to compensate and ensure the same depth of ink absorbing member is provided in the tank 12. The filter sheet 64 is attached to the underside 82 of the larger pore size ink absorbing member 60. The benefit of using two ink absorbing members of different pore size is that a capillary ramp is produced which aids emptying of the cartridge by attraction of ink from the larger pore size ink absorbing member 60 into the lower pore size ink absorbing member 62. That benefit is not achieved in the third embodiment, but one of the assembly steps can be omitted as there is only one ink absorbing member to be placed into the tank, rather than two.

The fourth embodiment is again similar to the third embodiment and the same reference numerals will be used for equivalent features. Whereas in the third embodiment, the low pore size porous member 62 was omitted, in the fourth embodiment it is the larger pore size member 60 which is omitted. The height of the lower pore size ink absorbing member 62 is unchanged so that there is a large open area above the low pore size absorbing member 62 for ink, so that the capacity of the tank is greater.

In further embodiments, filter material with pore sizes of 1 micrometre and 6 micrometres have been used successfully.

The embodiment of FIGS. 11 to 14 is similar to the first embodiment of the invention and the same reference numerals will be used for equivalent features. Only the differences from the first embodiment will be described.

As seen in FIGS. 11 and 14, the upper ink absorbing member 60 does not have a cut-out 72 and instead is of a regular, rectangular shape. In order to create an air gap, the lid 14 includes an upwards recess 90 to create an air gap 92 therein. The recess 90 has an upwardly directed opening constituting an air hole 94 replacing the tube 32. The recess 90 is generally rectangular and extends over the width of the lid 14.

In this way, an air gap 92 in advance of the air hole 94 can be provided, but the upper ink absorbing member does not have to be cut to include the cut-out 72, which avoids a manufacturing step, and furthermore there is no risk of inserting the upper ink absorbing member 60 the wrong way round, as it can be inserted either way round in this embodiment, which also facilitates the manufacturing process.

As shown in FIG. 12, the channel 20 in this embodiment is abbreviated and in fact the area of the groove 20 is the same as the area of the ink outlet tube 16. A spar 96 extends across the end of the ink outlet port 17 and terminates short of the end of the channel 20. The spar 96 prevents the filter sheet 64 from sagging into the outlet port 17.

One of the fuse bonding lines 68 is shown in phantom in FIG. 12 and it is seen that it lies adjacent the end of the channel 20. Indeed, this is the reason that the channel 20 is offset from the outlet port 17, namely, to ensure that the fuse bonding line 68 is clear of the channel 20 which forms the entrance to the ink outlet port 17.

1. A method of assembling an ink cartridge for a printer, the cartridge having an ink storage tank and an ink supply outlet from the tank, the method comprising the steps of: attaching a filter to a negative pressure producing member, and inserting the negative pressure producing member into the tank so that the filter is over the ink supply outlet.

2. A method as claimed in claim 1, wherein the width of the negative pressure producing member is such that the tank locates the negative pressure producing member in the width direction with the filter over the ink supply outlet.

3. A method as claimed in claim 1, wherein the negative pressure producing method is inserted so as to engage at least one end wall of the tank so that the tank locates the negative pressure producing member with the filter over the ink supply outlet.

4. A method as claimed in claim 1, wherein the negative pressure producing member is dimensioned such that the tank locates the negative pressure producing member in the horizontal longitudinal direction with the filter over the ink supply outlet.

5. A method as claimed in claim 1, wherein the negative pressure producing member frictionally engages at least two walls of the tank so as to hold itself in place.

6. A method as claimed in claim 1, wherein the negative pressure producing member frictionally engages four walls of the tank so as to hold itself in place.

7. A method as claimed in claim 1, wherein the filter is attached to the negative pressure producing member by application of heat to fuse the filter to the negative pressure producing member.

8. A method of assembling an ink cartridge for a printer, the cartridge having an ink storage tank and an ink supply outlet from the tank, the method comprising the steps of: placing a filter over the ink outlet and placing a negative pressure producing member into the tank, the negative pressure producing member holding the filter in place.

9. A method as claimed in claim 8, wherein the filter is arranged to engage the end of the wall of the tank in which the ink outlet is formed when located over the outlet.

10. A method as claimed in claim 8, wherein the filter has the same width as the width of the tank.

11. A method as claimed in claim 1, wherein the outlet is in the floor of the tank.

12. A method as claimed in claim 1, wherein the floor of the tank is flat.

13. A method as claimed in claim 1, wherein the negative pressure producing member is an extruded piece of fibrous material.

14. A method as claimed in claim 1, wherein the negative pressure producing member is made of plastics material.

15. A method as claimed in claim 1, wherein at least part of the filter is made of plastics material.

16. A method as claimed in claim 1, wherein the filter is in the form of a sheet.

17. A method as claimed in claim 1, wherein the filter is a woven material.

18-20 (cancelled)

21. A method as claimed in claim 1, wherein the effective area of the ink outlet increases into the tank.

22. A method as claimed in claim 1, wherein a channel is provided in the tank leading to the outlet.

23. A method as claimed in claim 1, wherein the ink outlet does not protrude beyond the floor of the tank.

24. A method as claimed in claim 1, wherein a second negative pressure producing member is placed on the opposite side of the first negative pressure producing member from the filter.

25. A method as claimed in claim 24, wherein the second negative pressure producing member has a larger pore size than the first negative pressure producing member.

26. A filter assembly for an ink cartridge for a printer, the assembly comprising a negative pressure producing member and a filter connected thereto.

27. A filter assembly as claimed in claim 26, wherein the filter is fuse bonded to the negative pressure producing member.

28. A filter assembly as claimed in claim 26, wherein the negative pressure producing member is an extruded piece of fibrous material.

29. A filter assembly as claimed in claim 26 wherein the negative pressure producing member is made of plastics material.

30. A filter assembly as claimed in claim 26, wherein at least part of the filter is made of plastics material.

31. A filter assembly as claimed in any claim 26, wherein the filter is in the form of a sheet.

32. A filter assembly as claimed in claim 26, wherein the filter is a woven material.

33-35 (cancelled)

36. An ink cartridge for a printer, the cartridge comprising an ink storage tank with an ink supply outlet from the tank, and a filter over the ink supply outlet but separate from the outlet and the tank.

37. An ink cartridge for a printer, the cartridge comprising an ink storage tank and an ink supply outlet from the tank, a negative pressure producing member held in place in the tank and the filter in place by the negative pressure producing member.

38. An ink cartridge as claimed in claim 37, wherein the filter is connected to the negative pressure producing member.

39 (cancelled)

40. An ink cartridge for a printer, the cartridge comprising a tank with a lid, the lid defining one or more of an air hole, an air gap, fill hole and extraction hole, and the under surface of the lid being flat.
